(19) United States
(12) Patent Application Publication
(10) Pub. No.: US 2019/0371284 A1
(43) Pub. Date: Dec. 5, 2019

(54) CLIP-ON MUSICAL INSTRUMENT TUNER WITH REMOVABLE PICK HOLDER

(71) Applicant: Stephen T. Ridinger, Irvine, CA (US)

(72) Inventor: Stephen T. Ridinger, Irvine, CA (US)

(21) Appl. No.: 15/997,918

(22) Filed: Jun. 5, 2018

(51) Int. Cl. G10D 3/16; G10D 3/14

(52) U.S. Cl. CPC G10D 3/163; G10D 3/14

(57) ABSTRACT

An article of manufacture comprising, in combination, a clip-on musical and a pick holder dimensioned and configured to attach reversibly via a friction fit to the musical instrument tuner.

### CROSS-REFERENCE TO RELATED APPLICATIONS

This application is related to co-pending U.S. design patent application Ser. No. 29/650,154, filed Jun. 5, 2018, which is incorporated herein by reference.

### BACKGROUND

“Tuning” is the process of adjusting the pitch of one or many tones from musical instruments to establish typical or desired intervals between these tones. Tuning is usually based on a fixed reference, such as the widely accepted A=440 Hz in western music. The term “out of tune” refers to a pitch/tone that is either too high (sharp) or too low (flat) in relation to a given reference pitch. While an instrument might be in tune relative to its own range of notes, it may not be considered “in tune” if it does not match the chosen reference pitch. Thus, for example, a guitar might be “in tune” relative to itself and can be played in conventional fashion as a solo instrument. However, if the “A” above middle C on the guitar is not set to 440 Hz, the guitar will be “out of tune” with respect to all other instruments tuned to the A-440 standard. Thus, the guitar would have to be re-tuned to play in combination with other instruments tuned to the A-440 standard.

Conventionally, the tuning of instruments for playing in an ensemble setting is accomplished by ear using a reference tone generated by a pitch pipe, a tuning fork, or a piano or organ. In an orchestra setting, it has been a long-standing tradition for the orchestra to tune to an “A” note played by the oboe. This is convenient because all of the string instruments used in an orchestra have an “A” string. Pitch pipes and tuning forks, however, have disadvantages, especially when playing solo. For example, the reference tone dies away quickly when using a pitchfork, which requires sounding it several times to ensure the instrument being tuned matches the reference tone. This is notably difficult when tuning stringed instruments such as guitars and violins, which require both hands to play.

Electromechanical and electronic musical instrument tuners are conventional devices and have been available commercially since the 1930's. See, for example U.S. Pat. No. 3,180,199, issued Apr. 27, 1965. These early devices used a microphone to pick up the tones being generated by instrument to be tuned. The devices were quite accurate, but large, cumbersome, and difficult to use in group settings because the microphone would detect errant noises in the room. In short, a tuner that uses a microphone is ineffective in loud environments.

In the mid- to late-1990's, commercial stringed instrument tuners appeared that functioned by clipping to the headstock of the instrument. These tuners measure pitch via a contact sensor that analyzes the vibrations emanating from the wood or metal of the instrument. Commercially available “clip-on” tuners are exemplified by the “SNARK”®-brand line of clip-on tuners. (“SNARK” is a registered trademark of Evets Corporation, Irvine, Calif.). The “SNARK”-brand line of commercial clip-on tuners is available in models specifically calibrated for guitars, as well as in chromatic versions that will tune in clip-on fashion for all instruments (not just guitars) and also include an on-board microphone for tuning woodwind and brass instruments.

When not finger-picked, guitars (both acoustic and electric) are typically played with a flat pick. Flat picks result in a much louder and percussive attack when playing the guitar. Flat picks, however, are often difficult to keep under control, especially when playing up-tempo songs. In professional settings, it is a common for the guitar player to tape several additional picks to a nearby microphone stand or to a top edge of the guitar itself. That way, when the pick being used is dropped or cracks (which happens regularly) a replacement pick can be quickly grasped. It is convenient to tape replacement picks to a top edge of the guitar using double-sided tape. However, it is well known to professional and amateur players alike that this mars the finish of the guitar. Thus, players of high-end modern instruments or collector-grade instruments (instruments whose prices are measured in thousands to tens of thousands of dollars) are hesitant to supply quick access to another pick by way of double-sided tape. As a result, a host of pick holding devices are described in the prior art. See, for example, U.S. Pat. Nos. 4,890,531; 5,127,300, 6,215,052; 9,047,849; and 9,370,568, and WO 2006/046918. A drawback of many, if not all of these devices is that they too are affixed to a surface of the instrument in a fashion that could mar the finish of the instrument. Also, they often can only be positioned in locations that are inconvenient to the player. For example, with a guitar, placing a pick holder on the pick guard of a guitar typically places the pick holder in the path of the player's strumming hand.

### SUMMARY

Disclosed herein is an article of manufacture comprising, in combination, a musical instrument tuner dimensioned and configured to attach reversibly to a musical instrument without using tools, and a pick holder dimensioned and configured to attach reversibly via a friction fit to the musical instrument tuner. The pick holder generally has a top wall, depending front and rear walls, and depending side walls connecting the front and rear walls, wherein the top, front, rear, and side walls define an internal space configured to attach reversibly via friction to the tuner. The top wall defines at least one through channel dimensioned and configured to reversibly retain a musical instrument pick therein.

The through channels preferably include at least one first protrusion extending from a first wall of the channel and at least one second protrusion extending from an opposite wall of the channel toward the first protrusion. In preferred versions, the pick holder one, two, three, or more such pick-holding channels and their associated protrusions.

A particular advantage of the pick holder is that it positions a replacement pick on the instrument, within easy reach of the player (at the head stock), while simultaneously not in a location that interferes with the player's ability to play the instrument. For a right-handed guitar player, the right hand holds the pick. When the pick is dropped, it is an easy matter to reach over with the right hand to the headstock and secure a replacement pick. This is in contrast to placing a pick holder almost anywhere else on the body of the guitar. When located on the top surface of the guitar, a conventional pick holder either interferes with the player's strumming style, interferes with easy access to the volume, tone and pickup selectors (on electric guitars), or alters the tone of the instrument (most notable with acoustic guitars).

### BRIEF DESCRIPTION OF THE DRAWINGS

FIG. 1 is an exploded front perspective rendering of the clip-on instrument tuner and removable pick holder according to the present disclosure.

FIG. 2 is front perspective rendering of the clip-on instrument tuner and removable pick holder according to the present disclosure with the pick holder reversibly attached to the housing of the clip-on tuner.

FIG. 3 is a rear perspective rendering of the clip-on instrument tuner and reversibly attached pick holder as shown in FIG. 2.

FIG. 4 is a front perspective rendering of the pick holder.

FIG. 5 is a bottom perspective rendering of the pick holder as seen in FIG. 4.

FIG. 6 is a front elevation of the pick holder as seen in FIG. 4.

### DETAILED DESCRIPTION

Numerical ranges as used herein are intended to include every number and subset of numbers contained within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 1 to 9, from 3.6 to 4.6, from 3.5 to 9.9, and so forth.

All references to singular characteristics or limitations of the present disclosure shall include the corresponding plural characteristic or limitation, and vice-versa, unless otherwise specified or clearly implied to the contrary by the context in which the reference is made. The indefinite articles “a” and “an” mean “one or more” unless explicitly defined to the contrary.

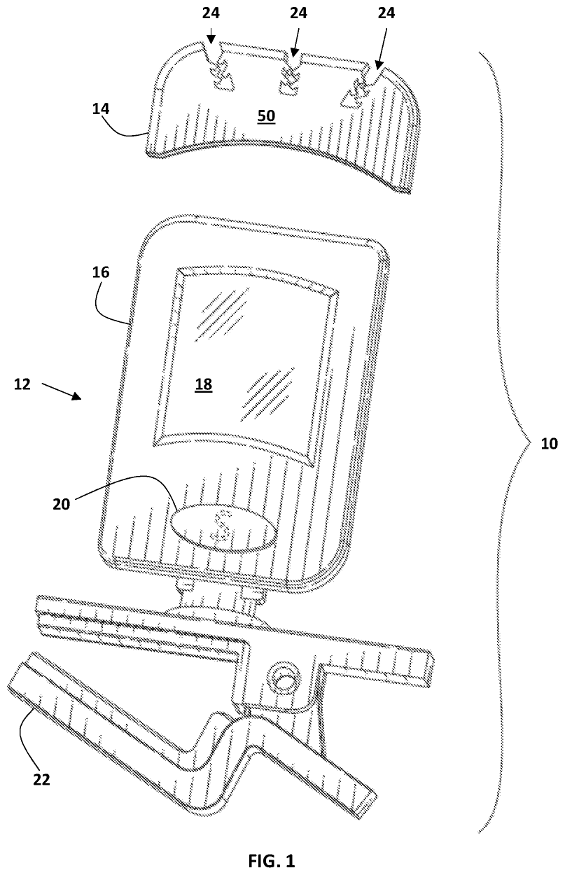

Referring now to the figures, where identical reference numerals are used throughout, FIG. 1 is an exploded front perspective rendering of the clip-on instrument tuner and removable pick holder 10 according to the present disclosure. Shown in FIG. 1 is an article of manufacture comprising, in combination, a clip-on tuner 12 of conventional design, and a reversibly attachable pick holder 14.

The tuner 12 is of a clip-on design and includes a housing 16 enclosing a tuning circuit (not shown). The housing 16 includes a graphic display 18 for conveying tuning information to the user. Also included is a function control 20. The housing 16 is reversibly attached to a fastener 22. The fastener 22 is in the form of a clip or clamp that is dimensioned and configured to attached the entire tuner apparatus 12 onto the headstock of a stringed instrument such as a guitar, bass guitar, violin, viola, cello, mandolin, ukele, banjo, and the like.

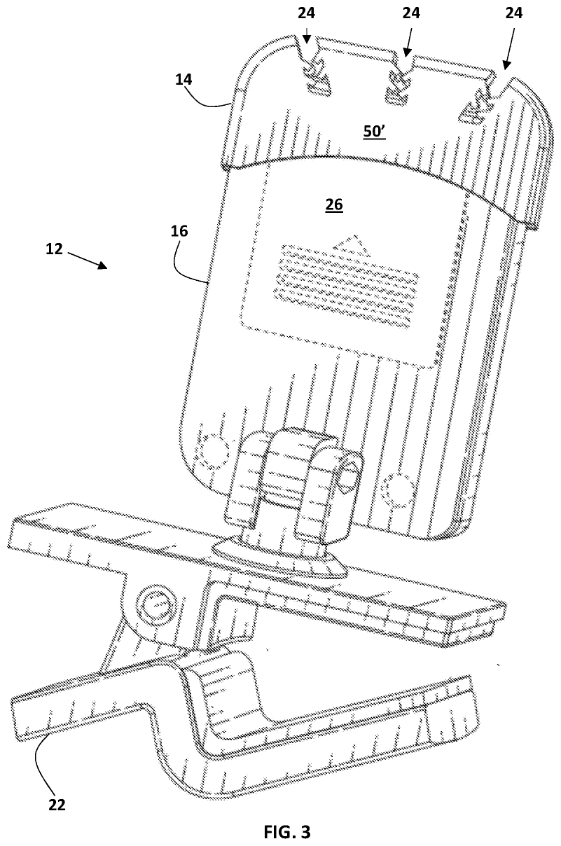

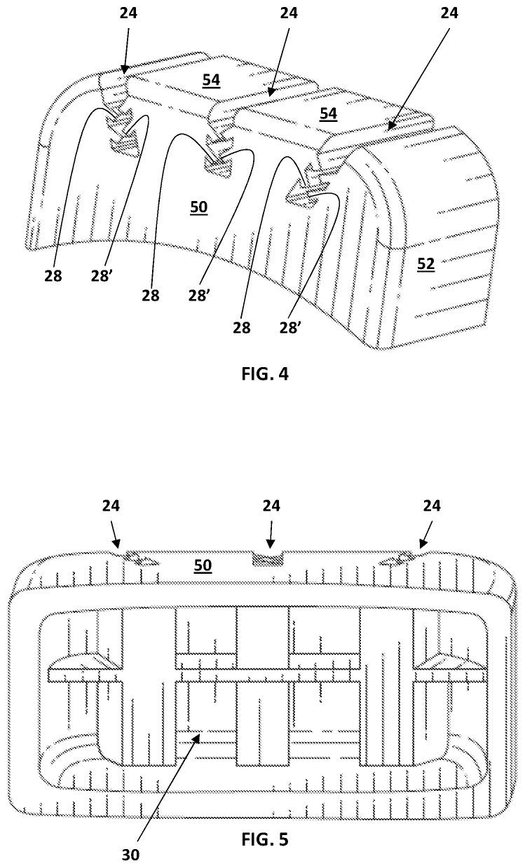

As shown in FIG. 1, the article of manufacture also comprises, in combination, a pick holder 14. The pick holder includes front wall 50 and wall 50′ (shown in FIG. 3) connected by side walls 52 and top wall 54 (shown in FIG. 4). The pick holder has defined within it a plurality of pick-holding channels 24. The pick-holding channels 24 are through channels that extend across the width of the pick holder with openings through the front wall 50 and rear wall 50′ (see FIG. 3). In this fashion, the pick-holding channels are dimensioned and configured to releasibly retain a pick or plectrum of almost any size or shape. Guitar picks come in a wide variety of shapes and thicknesses. For example, picks for use with bass guitars (whose strings are much more massive than those of a regular guitar) tend to be on the large side and are made of thicker, stiffer stock.

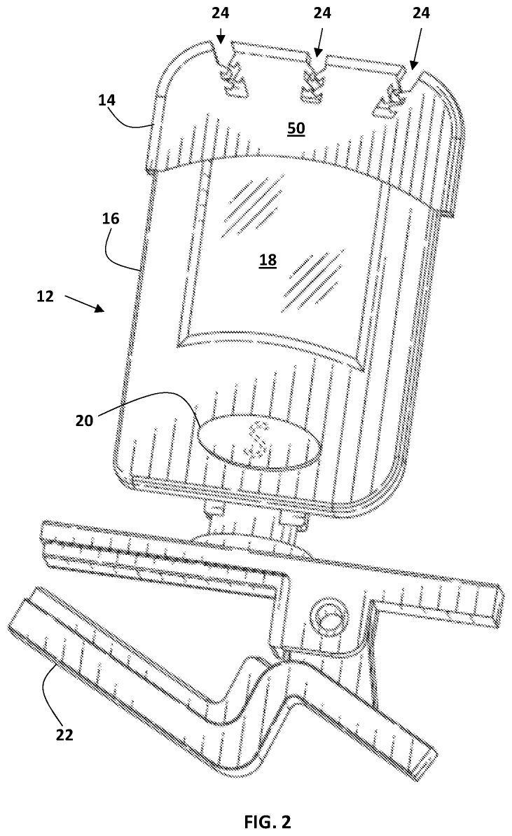

The pick holder 14 is preferably made from a thermoplastic or thermosetting elastomeric material, such as natural or synthetic rubbers, acrylonitrile-butadiene-styrene (ABS), polyethylene (PE), including high-density polyethylene (HDPE) and low-density polyethylene (LDPE), polypropylene (PP), polyamides, polystyrenes, and the like. The pick holder can also be made from composite materials or a combination of different materials (such as a more flexible material for the portion that abuts the housing of the tuner and a more rigid portion for the pick-holding channels 24). It is preferred, but not required that the pick holder is made via injection molding. The method of manufacture, however, is not critical to the design. The pick holder may be made by an suitable fabrication method now known or developed in the future. The material chosen should be suitable flexible to allow the pick holder to be easily affixed to and removed from the housing of the tuner via a friction engagement (contrast FIG. 1 to FIG. 2), while at the same time providing a sufficiently tight friction engagement so that the pick holder will not accidentally be dislodged from the housing of the tuner.

Referring to FIGS. 2 and 3, FIG. 2 is front perspective rendering of the clip-on instrument tuner and the removable pick holder with the pick holder reversibly attached to the housing of the clip-on tuner. FIG. 3 shows the same rendering from the rear. As shown in the figures, the pick holder 14 is reversibly attached to the housing 16 of the guitar tuner 12 via a friction fit. As can be seen in these two figures, the pick-holding channels 24 are through channels. A battery access panel 16 in the tuner 12 is shown in

Referring now to FIGS. 4, 5, and 6, these three figures show a front perspective rendering of the pick holder, a bottom perspective rendering of the pick holder, and a front elevation of the pick holder, respectively. As shown in FIG. 4, the pick holder includes a front wall 50 (and a rear wall 50′ shown in FIG. 3) connected by sidewalls 52, and top wall 54. Passing through the top wall 54 and front and rear walls 50 and 50′ are several through channels 24 which are dimensioned and configured to reversibly hold a musical instrument pick (not shown). The walls defining each of the through channels 24 include a several opposed, finger-like protrusions or teeth 28 and 28′. As shown in the FIGS. 4 and 6, the protrusions 28 and 28′ run the length of each of the respective channels 24. The end of each protrusion is shown as 90° angles extending. The protrusions 28 and 28′ are also generally oriented so that they angle downward, away from the top wall 54. In this fashion, when a pick is inserted into a channel 54, the protrusions are deformed downwardly, away from top wall, 54, and generally filling most of the volume within each channel 54. Thus, when a pick is withdrawn from the channel 24, the friction of each of the protrusions 28 and 28′ against the pick tends to retain the pick within the channel 24. This arrangement provides a very firm, but reversible attachment with a pick that gives confidence to the player: the pick will stay in place within the channel 24 until it is purposefully removed when needed. The width of each channel 24 and the length of each protrusion 28 and 28′ into each channel 24 is dimensioned and configured so that a pick, once inserted into a channel 24 is retained there until purposefully removed by a user.

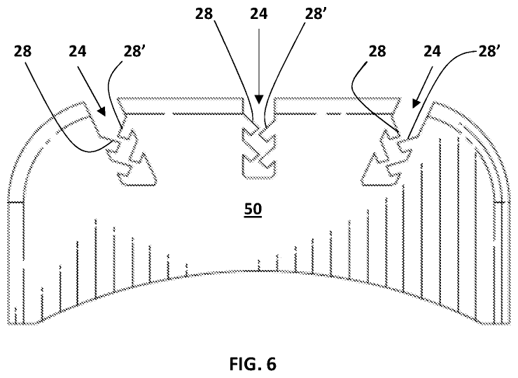

The front wall 50, rear wall 50′, side walls 52 and top wall 54 of the pick holder 14 cooperate to define an internal space or housing 30, as shown in FIG. 5. The shape and dimensions of the internal space 30 are such that the housing 16 of the tuner 12 fits snugly with the internal space 3a0 via a friction fit. Compare FIGS. 1 and 2. In this fashion, a player that wants to use the pick holder in combination with the tuner simply slides the pick holder 14 onto the end of the tuner 12 as shown in FIG. 2. Picks are then inserted and removed from the channels 24. If a player wants only to use the tuner 12, the pick holder 14 may be removed from the tuner, as shown in FIG. 1.

The combination disclosed herein as many immediate benefits. First, it combines two accessories, a clip-on tuner and a pick holder, that are widely used by string instrument players, especially guitar players.

Second, it puts a replacement pick always within reach of the player. Because the tuner 12 is attached to the musical instrument, and the pick holder 14 is attached to the tuner, wherever the instrument goes, so goes the picks held by the pick holder 14. This is very important in the context of paid performances, where, for example a singer/guitar player may wander away from the microphone stand while playing an instrumental tune (or instrumental portion of a tune). If replacement picks are taped to the mic stand, the guitar player might have to rush back to the mic stand to get a pick (all the while either not playing or doing as best he can do finger style until he retrieves a pick). With the present invention, the player needs only reach toward the headstock of the instrument to retrieve a replacement pick. It can be accomplished in an instant.

Third, the combination provides a readily accessible place to store replacement picks where they can be very quickly and easily retrieved without marring the surface of the musical instrument, without any modification whatsoever to the instrument, and without the use of tools.

Lastly, the combination can be moved from instrument to instrument by simply activating the clamp 22 and moving the entire combination of tuner 12 and pick holder 14 to a different instrument.

1. An article of manufacture comprising, in combination:
a musical instrument tuner having a housing;
a fastener reversibly attached to the housing, wherein the fastener is dimensioned and configured to attach reversibly to a musical instrument without using tools; and
a pick holder dimensioned and configured to attach reversibly via a friction fit to the housing of the musical instrument tuner.

2. The article of manufacture of claim 1, wherein
the pick holder has a top wall, depending front and rear walls, and depending side walls connecting the front and rear walls, wherein the top, front, rear, and side walls define an internal space configured to attach reversibly via friction to the housing of the musical instrument tuner; and
the top wall defines at least one through channel dimensioned and configured to reversibly retain a musical instrument pick therein.

3. The article of manufacture of claim 2, wherein the at least one through channel includes at least one first protrusion extending from a first wall of the channel and at least one second protrusion extending from an opposite wall of the channel toward the first protrusion.

4. The article of manufacture of claim 2, wherein the top wall defines two through channels, each dimensioned and configured to reversibly retain a musical instrument pick therein.

5. The article of manufacture of claim 4, wherein each of the two through channels includes at least one first protrusion extending from a first wall of each channel and at least one second protrusion extending from an opposite wall of each channel toward the first protrusion.

6. The article of manufacture of claim 2, wherein the top wall defines three through channels, each dimensioned and configured to reversibly retain a musical instrument pick therein.

7. The article of manufacture of claim 4, wherein each of the three through channels includes at least one first protrusion extending from a first wall of each channel and at least one second protrusion extending from an opposite wall of each channel toward the first protrusion.
